(19) United States
(12) Patent Application Publication
(10) Pub. No.: US 2020/0308384 A1
(43) Pub. Date: Oct. 1, 2020

(54) Ethylene-Acrylate Copolymer Blends

(71) Applicant: ExxonMobil Chemical Patents Inc., Baytown, TX (US)

(72) Inventors: Maksim Shivokhin, Houston, TX (US); Patrick Brant, Seabrook, TX (US)

(21) Appl. No.: 16/829,833

(22) Filed: Mar. 25, 2020

Related U.S. Application Data
(60) Provisional application No. 62/826,297, filed on Mar. 29, 2019.

(51) Int. Cl. C08L 23/12; C08L 23/14; C08L 33/08

(52) U.S. Cl. CPC C08L 23/12; C08L 2207/10; C08L 33/08; C08L 23/14

(57) ABSTRACT

This invention relates to a composition can include a propylene polymer and up to about 60 wt % of an ethylene-acrylate copolymer, based on a weight of the propylene polymer and the ethylene-acrylate copolymer. The composition can have a strain hardening ratio of greater than 1 to about 15, where the extensional viscosity is measured at a Hencky strain rate of 1 s⁻¹ and at a temperature of 190° C. The ethylene-acrylate copolymer can include units derived from ethylene and at least 5 mol % of units derived from a C₁-C₄ alkyl acrylate.

### CROSS REFERENCE TO RELATED APPLICATIONS

This application claims priority to U.S. Ser. No. 62/826297, filed Mar. 29, 2019, herein incorporated by reference.

### FIELD

This invention relates to ethylene-acrylate copolymer blends. More particularly, this invention relates to blends containing an ethylene-acrylate copolymer and a propylene polymer, such as isotactic polypropylene or a propylene-based elastomer.

### BACKGROUND

Propylene polymers are known to have low melt strength, which is a significant drawback for use in thermoforming, foaming, blow molding, and other processes. The negative impact in the low melt strength of propylene polymers manifests as excess sag in sheet extrusion, rapid thinning of walls in parts thermoformed in the melt phase, low draw-down ratios in extrusion coating, poor bubble formation in extrusion foam materials, and relative weakness in large parts produced by blow molding. Propylene polymers produced using conventional slurry processes and catalyst systems yield granular products that are highly linear and generally have insufficient melt strength for a number of foamed or thermoformed applications. High melt strength propylene polymers are only available through expensive treatments such as post-reactor reactions with a peroxydicarbonate or in-reactor reactions via reinsertion of vinyl terminated macromonomers.

There is a need, therefore, for improved processes to produce higher melt strength polymers for use in thermoforming, foaming, blow molding, and other processes.

References of interest include: Pesneau, I. et al. (2002) Journal of Cellular Plastics, v.38(5), pp. 421-440; Genovese, A. et al. (2003) Journal of Applied Polymer Science, v.90, pp. 175-185; Sarkhel, G. et al. (2006) Polymer-Plastics Technology and Engineering, v.45, pp. 713-718; M. Sugimoto (2008) Nihon Reoroji Gakkaishi, v.36(5), pp. 219-228.

### SUMMARY

Ethylene-acrylate copolymer blends are provided. In some examples, a composition can include a propylene polymer and up to about 60 wt % of an ethylene-acrylate copolymer, based on a weight of the propylene polymer and the ethylene-acrylate copolymer. The composition can have a strain hardening ratio of greater than 1 to about 10, where the extensional viscosity is measured at a Hencky strain rate of 1 s⁻¹ and at a temperature of about 190° C. The ethylene-acrylate copolymer can include units derived from ethylene and at least 5 mol % of units derived from a C₁-C₄ alkyl acrylate.

In some examples, a composition can include, based on a weight of polypropylene-based elastomer and ethylene-acrylate-copolymer, about 40 wt % to about 99.5 wt % of a propylene-based elastomer. The propylene-based elastomer can include units derived from propylene and about 3 wt % to about 35 wt % by weight of units derived from ethylene and/or units derived from a C₄-C₂₀ alpha-olefin, based on a weight of the propylene-based elastomer. The propylene-based elastomer can have a heat of fusion, as determined by ASTM E793-06 (2018) of less than or equal to 75 J/g, and a melting point, as determined by ASTM D3418-15, of less than or equal to 110° C. The composition can also include about 0.5 wt % to about 60 wt % of a ethylene-acrylate copolymer that can include units derived from ethylene and at least 5 mol % of units derived from a C₁-C₄ alkyl acrylate, the ethylene-acrylate copolymer can have a melt flow rate, as determined by ASTM D1238-13 at 2.16 kg, 190° C., of less than 4 g/10 min The composition can a strain hardening ratio of greater than greater than 1 to about 10, where the extensional viscosity is measured at a Hencky strain rate of 1 s⁻¹ and at a temperature of 190° C.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a graph of extensional viscosity data versus time used to calculate strain hardening ratio.

FIG. 2 depicts a graph of the flex modulus (top) and stress/strain at break (bottom) of blends of a polypropylene random copolymer (EXXONMOBIL™ PP9513) and an ethylene methyl acrylate copolymer (OPTEMA™ TC110).

FIG. 3 depicts a graph of the flex modulus (top) and stress/strain at break (bottom) of blends of a polypropylene homopolymer (EXXONMOBIL™ PP3155) and an ethylene methyl acrylate copolymer (OPTEMA™ TC110).

FIG. 4 depicts a graph of the flex modulus (top) and stress/strain at break (bottom) of a propylene-based elastomer (VISTAMAXX™ 3980) and an ethylene methyl acrylate copolymer (OPTEMA™ TC110).

FIG. 5 depicts a graph of the flex modulus (top) and stress/strain at break (bottom) of a high melt strength polypropylene homopolymer (ACHIEVE™ Advanced PP6282 also referred to as PDH002) and an ethylene methyl acrylate copolymer (OPTEMA™ TC110).

FIG. 6 depicts a graph of extensional viscosity data of an ethylene methyl acrylate copolymer (OPTEMA™ TC110), an isotactic polypropylene homopolymer (EXXONMOBIL™ PP1024E4), and the 20/80 and 40/60 blends of PP1024E4/TC110.

FIG. 7 depicts a graph of extensional viscosity data of an ethylene methyl acrylate copolymer (OPTEMA™ TC110), a high melt strength polypropylene homopolymer (ACHIEVE™ Advanced PP6282 also referred to as PDH002), and the 20/80 and 40/60 blends of PP6282/TC110.

FIG. 8 depicts a graph of extensional viscosity data of an ethylene methyl acrylate copolymer (OPTEMA™ TC110), a polypropylene random copolymer (EXXONMOBIL™ PP9513), and the 20/80 and 40/60 blends of PP9513/TC 110.

FIG. 9 depicts a graph of extensional viscosity data of an ethylene methyl acrylate copolymer (OPTEMA™ TC110), a propylene homopolymer (EXXONMOBIL™ PP3155), and the 20/80 and 40/60 blends of PP3155/TC110.

FIG. 10 depicts a graph of extensional viscosity data of an ethylene methyl acrylate copolymer (OPTEMA™ TC110), a propylene-based elastomer (VISTAMAXX™ 3980), and the 20/80 and 40/60 blends of VMX3980/TC 110.

FIG. 11 depicts a graph of small angle oscillatory shear data of an ethylene methyl acrylate copolymer (OPTEMA™ TC110), an isotactic polypropylene homopolymer (EXXONMOBIL™ PP1024E4), and the 20/80 and 40/60 blends of PP1024E4/ TC110.

FIG. 12 is a magnified view of the melt blends of an ethylene methyl acrylate copolymer (OPTEMA™ TC110) and an isotactic polypropylene homopolymer (EXXONMOBIL™ PP1024E4).

FIG. 13 is a picture of compression molded plaques of a propylene-based elastomer (VISTAMAXX^{TM} 3980) and the 20/80 and 40/60 blends of VISTAMAXX3980/TC 110.

### DETAILED DESCRIPTION

It is to be understood that the following disclosure describes several exemplary embodiments for implementing different features, structures, and/or functions of the invention. Exemplary embodiments of components, arrangements, and configurations are described below to simplify the present disclosure; however, these exemplary embodiments are provided merely as examples and are not intended to limit the scope of the invention. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the Figures. Moreover, the exemplary embodiments presented below can be combined in any combination of ways, i.e., any element from one exemplary embodiment can be used in any other exemplary embodiment, without departing from the scope of the disclosure.

Definitions

An “olefin,” alternatively referred to as an “alkene,” is a linear, branched, or cyclic compound of carbon and hydrogen having at least one double bond. For purposes of this specification and the claims appended thereto, when a polymer or copolymer is referred to as comprising an olefin, the olefin present in such polymer or copolymer is the polymerized from of the olefin. For example, when a copolymer is said to have an “ethylene” content of 35 wt % to 55 wt %, it is understood that the mer unit in the copolymer is derived from ethylene in the polymerization reaction and said derived units are present at 35 wt % to 55 wt %, based on a weight of the copolymer. A “polymer” has two or more of the same or different mer units. A “homopolymer” is a polymer having mer units that are the same. A “copolymer” is a polymer having two or more mer units that are different from each other. A “terpolymer” is a polymer having three mer units that are different from each other. Accordingly, the definition of copolymer, as used herein, includes terpolymers and the like. “Different” as used to refer to mer units indicates that the mer units differ from each other by at least one atom or are different isomerically. An “ethylene polymer” or “ethylene copolymer” is a polymer or copolymer that includes at least 50 mol % of ethylene derived units, a “propylene polymer” or “propylene copolymer” is a polymer or copolymer that includes at least 50 mol % of propylene derived units, and so on.

The term “alpha-olefin” refers to an olefin having a terminal carbon-to-carbon double bond in the structure thereof ((R¹R²)—C═CH₂, where R¹ and R² can independently be hydrogen or any hydrocarbyl group; preferably R¹ is hydrogen and R² is an alkyl group). A “linear alpha-olefin” is an alpha-olefin defined in this paragraph where R¹ is hydrogen, and R² is hydrogen or a linear alkyl group.

For the purposes of this disclosure, ethylene is considered an α-olefin.

As used herein, and unless otherwise specified, the term “Cₙ” means hydrocarbon(s) having n carbon atom(s) per molecule, where n is a positive integer. Likewise, a “Cₘ-C_{y}” group or compound refers to a group or compound comprising carbon atoms at a total number thereof in the range from m to y. Thus, a C₁-C₄ alkyl group refers to an alkyl group that includes carbon atoms at a total number thereof in the range of 1 to 4, e.g., 1, 2, 3 and 4.

As a general definition, a miscible blend of a two-component system forms a homogeneous system that is a single phase. That is, the first polymeric component has some degree of solubility in the second polymeric component. The term miscibility does not imply ideal molecular mixing. In contrast, an immiscible blend of a two-component system remains a two-phase system, and the two-phase nature can often be revealed using optical microcopy or electron microscopy. A co-continuous blend of a two-component system is considered a two phase system.

In some examples, a composition can include a propylene polymer and up to 60 wt % of an ethylene-acrylate copolymer, based on a weight of the propylene polymer and the ethylene-acrylate copolymer, where the composition can have a strain hardening ratio of greater than 1 to 10, where an elongational viscosity is measured at a Hencky strain rate of 1 s⁻¹ and at a temperature of 190° C. and where the ethylene-acrylate copolymer includes units derived from ethylene and at least 5 mol % of units derived from a C₁-C₄ alkyl acrylate, based on a weight of the ethylene-acrylate copolymer.

In some examples, a composition can include about 40 wt % to 99 wt % of a propylene-based elastomer and about 1 wt % to about 40 wt % of an ethylene-acrylate copolymer, based on a weight of the propylene-based elastomer and the ethylene-acrylate copolymer. The propylene-based elastomer can include units derived from propylene and about 3 wt % to 35 wt % by weight of units derived from ethylene and/or units derived from a C₄ to C₂₀ alpha-olefin, based on a weight of the propylene-based elastomer. The propylene-based elastomer can have a heat of fusion, as determined by ASTM E793-06 (2018) of less than or equal to 75 J/g, and a melting point, as determined by ASTM D3418-15, of less than or equal to 110° C. The ethylene-acrylate copolymer can include units derived from ethylene and at least 5 mol % of units derived from a C₁-C₄ alkyl acrylate, based on a weight of the ethylene acrylate copolymer. The ethylene-acrylate copolymer can have a melt flow rate, as determined by ASTM D1238-13 at 2.16 kg, 190° C., of less than 4 g/10 min. The composition can have a strain hardening ratio of greater than 1 to about 10, where the elongational viscosity is measured at a Hencky strain rate of 1 s⁻¹ and at a temperature of 190° C.

It has been surprisingly and unexpectedly discovered that blending a branched ethylene-acrylate copolymer with a linear propylene polymer or a propylene-based elastomer yields matrix rheological properties favorable for various plastics fabrication processes, e.g., foaming and thermoforming processes.

### Ethylene-Acrylate Copolymer

In some examples, the ethylene-acrylate copolymer can be copolymers of ethylene and at least one comonomer, where the comonomer is an alkyl acrylate. Suitable comonomers can include the acrylic acid of C₁ to C₁₂ linear or branched alcohols, or in some examples, the acrylic acid of C₁ to C₈ linear or branched alcohols. Examples of alkyl acrylates suitable for use as a comonomer can be or include, but are not limited to, methyl acrylate, ethyl acrylate, propyl-acrylate, n-propyl acrylate, n-butyl acrylate, iso-butyl acrylate, t-butyl acrylate, n-hexyl acrylate, 2-ethylbutyl acrylate, and 2-ethylhexyl acrylate, as well as the acrylic acid esters of neo-isomers of C₅ to C₁₂ alcohols.

In some examples, the ethylene-acrylate copolymer can include at least 5 mol %, from 5 mol % to 20 mol %, 5 mol % to 15 mol %, 6 mol % to 14 mol %, or 7 mol % to 12 mol % of comonomer derived units. In some examples, the copolymer can include a lower limit of at least 5 mol % or at least 6 mol % or at least 7 mol % of comonomer-derived units, and an upper limit of 20 mol % or 14 mol % or 12 mol % of comonomer derived units.

The alkyl acrylate monomers can be used alone or in mixtures. Monomers other than ethylene and the alkyl acrylate can optionally be included. These additional monomers can include vinyl esters, such as vinyl acetate, and monomers such as acrylic acid, methacrylic acid, partial esters of maleic acid, and/or carbon monoxide.

In some examples, the ethylene-acrylate copolymer can include ethylene, an alkyl acrylate, or a mixture thereof; and a comonomer having a reactivity ratio r₂ relative to ethylene of 2 or less, or 1.5 or less, or 1.2 or less, or about 1. Exemplary comonomers having such a reactivity ratio can include vinyl esters, such as vinyl acetate, vinyl formate, and vinyl propionate. Reactivity ratios r₂ are well known in the art, and are described, for example, in Encyclopedia of Polymer Science and Engineering, v.6, p.401-403 (1986) (John Wiley, New York); and Encyclopedia of Chemical Technology, 4th Ed., v.17, p. 718-719 (1996) (John Wiley, New York).

In some examples, the ethylene-acrylate copolymer can be produced in a high-pressure tubular reactor. High pressure tubular reactors for producing ethylene alkyl acrylate copolymers are well known and can include those disclosed in U.S. Pat. No. 2,953,551. The ethylene-acrylate copolymer production is not limited to any specific tubular reactor design, operating pressure, operating temperature, or initiator system. The reactor can be capable of injection of an initiator into the reaction stream at least two, at least three, or at least four locations along the reaction tube.

The tubular reactor can be an elongated jacketed tube or pipe, usually in sections or blocks, of suitable strength and diameter. A typical tubular reactor can have a length to diameter ratio of from about 1,000 to about 1 to about 60,000 to about 1. The tubular reactor can be operated at pressures from about 1,000 bar to about 3,500 bar, although pressures higher than 3,500 bar can be used if desired.

The temperature maintained in the reactor can be variable, and can be primarily controlled by and dependent on the specific initiator system employed. Temperature in the reactor can be about 100° C. to about 350° C., and can vary in the different reaction zones.

An example of a high-pressure tubular reactor suitable for use in producing the ethylene-acrylate copolymers can be as disclosed in U.S. Pat. No. 4,135,044. If the reactor shown in U.S. Pat. No. 4,135,044 is used, the reactor can be operated without the use of cold side-streams.

The polymerization reaction can be carried out in the presence of free radical initiators. Such initiators are well known in the art. Specific non-limiting examples of such free radical initiators can be or include, but are not limited to, oxygen; peroxide compounds such as hydrogen peroxide, decanoyl peroxide, t-butyl peroxy neodecanoate, t-butyl peroxy pivalate, 3,5,5-trimethyl hexanoyl peroxide, diethyl peroxide, t-butyl peroxy-2-ethyl hexanoate, t-butyl peroxy isobutyrate, benzoyl peroxide, t-butyl peroxy acetate, t-butyl peroxy benzoate, di-t-butyl peroxide, t-amyl peroxy neodecanoate, t-amyl peroxy pivalate, t-amyl peroxy-2-ethyl hexanoate and 1,1,3,3-tetramethyl butyl hydroperoxide; alkali metal persulfates, perborates and percarbonates; azo compounds such as azo bis isobutyronitrite, or any mixture thereof. The initiator can be organic peroxides. Mixtures of such initiators can also be used, and different initiators and/or different initiator mixtures can be used in the different initiator injections. The initiator can be added to the reaction stream in any suitable manner, such as neat, dissolved in a suitable solvent, and/or mixed with the monomer or comonomer feed stream.

As noted above, an initiator can be injected into the reaction stream in at least two locations, at least three locations, or at least four locations. In some examples, the monomers and comonomers can be introduced into the tubular reactor at a single location, so that injection of additional initiator at a second, a third, a fourth, and subsequent location(s), are not accompanied by injection of any additional ethylene or comonomer.

The reaction can also be carried out in the presence of conventional modifiers, such as chain transfer agents. Typical chain transfer agents can include non-copolymerizable chain transfer agents, such as: saturated aliphatic aldehydes, e.g., formaldehyde, acetaldehyde, or propionaldehyde; saturated aliphatic ketones, e.g., acetone, diethyl ketone and diamyl ketone; saturated aliphatic alcohols, e.g., methanol, ethanol and propanol; paraffins and cycloparaffins e.g., pentane, hexane and cyclohexane; aromatic compounds, e.g., toluene, diethylbenzene and xylene; and other compounds which act as chain terminating agents such as propylene, carbon tetrachloride and chloroform. The chain transfer agents can be non-copolymerizable, such as acetaldehyde.

Alternatively, copolymerizable chain transfer agents, including propylene, isobutylene, 1-butene, etc., can be used either alone as a class or in combination with non-copolymerizable chain transfer agents. Polymers made using copolymerizable chain transfer agents will usually have peak melting temperatures less than the maximum attainable for the copolymer composition and reactor conditions used.

In some examples, the ethylene-acrylate copolymer can have a melt flow rate, as determined by ASTM D1238-13 at 2.16 kg, 190° C., of less than 10 g/10 min, less than 5 g/10 min, less than 4 g/10 min, less than 3 g/10 min, less than 2.5 g/10 min, less than 2 g/10 min, or less than 1.5 less g/10 min

In some examples, the ethylene-acrylate copolymer can have a melt index, as determined by ASTM D1238-13 at 2.16 kg, 190° C., of less than 10 g/10 min, less than 5 g/10 min, less than 4 g/10 min, less than 3 g/10 min, less than 2.5 g/10 min, less than 2 g/10 min, or less than 1.5 less g/10 min

In some examples, the ethylene-acrylate copolymer can have a g′vis branching index of 0.70 or less, or 0.60 or less, or from 0.30 to 0.70, or from 0.40 to 0.60 as determined by the GPC method described herein.

In some examples, the ethylene-acrylate copolymer can have a Vicat Softening Point, as determined by ASTM 1525-17e1 using a 200 g load instead of a 1,000 g load of at least 30° C., at least 35° C., at least 40° C., at least 45° C., at least 50° C., at least 55° C., or at least 60° C.

In some examples, the ethylene-acrylate copolymers can have a maximum peak melting temperature, as determined by ASTM D3418-15 of at least 100° C., at least 105° C., or at least 110° C.

In some examples, the ethylene-acrylate copolymer at 190° C. can have a zero-shear viscosity of about 500 kPa·s, about 1,000 kPa·s about 2,000 kPa·s, or about 3,000 kPa·s, about 5,000 kPa·s, about 8,000 kPa·s to about 10,000 kPa·s., 15,000 kPa·s, about 20,000 kPa·s about 25,000 kPa·s, or about 30,000 kPa·s, as defined by fitting dependence of complex viscosity on angular frequency data by Carreau-Yasuda model using TA Instruments Trios v3.3.1.4246 software.

$$\frac{η * ( ω ) - {η}_{∞}}{{η}_{0} - {η}_{∞}} = \frac{1}{{[ 1 + {( k ω )}^{a} ]}^{( 1 - n ) / a}} ,$$

with η₀ the zero-shear viscosity, η_{∞} the infinite viscosity, k the consistency and n the power law index and an a parameter describing the transition index between Newtonian plateau and power law region.

In some examples, the ethylene-acrylate copolymer at 190° C. can have a transition index of about 0.1, about 0.2, about 0.3, or about 0.4 to about 0.5, about 0.6, about 0.7, about 0.8, or about 0.9 as determined by the Carreau-Yasuda model.

In some examples, the ethylene-acrylate copolymer at 190° C. can have a consistency (characteristic time) of about 0.5 s, about 1 s, about 2 s, or about 3 s to about 4 s, about 5 s, about 6 s, or about 7 s as determined by the Carreau-Yasuda model.

In some examples, the ethylene-acrylate copolymer at 190° C. can have an infinite-rate viscosity of about −60 Pa·s, about −50 Pa·s, about −40 Pa·s, about −30 Pa·s to about −20 Pa·s, about −10 Pa·s, or about 0 Pa·s, as determined by the Carreau-Yasuda model.

In some examples, the ethylene-acrylate copolymers at 190° C. can have a power law index of about 0.05, about 0.1, about 0.2, or about 0.3 to about 0.7, about 0.8, about 0.9, about 1.0, about 1.1, or about 1.2 as determined by the Carreau-Yasuda model.

### Propylene Polymers

The propylene polymer can be a polypropylene homopolymer, random copolymer, block copolymers, or any mixture thereof. Random copolymers, also known as statistical copolymers, are polymers in which the propylene and the comonomer(s) are randomly distributed throughout the polymeric chain in ratios corresponding to the feed ratio of the propylene to the comonomer(s). Block copolymers are made up of chain segments consisting of propylene homopolymer and of chain segments consisting of, for example, random copolymers of propylene and ethylene. The propylene copolymer can be copolymers of propylene and one or more olefins selected from ethylene or linear or branched C₄ to C₂₀ a-olefins, in some examples, ethylene or C₄ to C₈ alpha-olefins, in some examples ethylene, 1-butene, 1-hexene, 4-methyl-1-pentene, 3-methyl-1-pentene, 3,5,5-trimethyl-1-hexene, and 1-octene, and some examples 1-butene, and optionally, minor amounts of non-conjugated diolefins, such as C₆-C₂₀ diolefins. In some examples, the alpha-olefin can contain cyclic structures that are fully saturated such that the alpha-olefin monomer does not contain a cyclic moiety with any olefinic unsaturation or any aromatic structures. In some examples, the alpha-olefins can be mono-olefins. The propylene copolymers can be prepared by polymerization of the olefins in the presence of supported or unsupported metallocene catalyst systems.

Polypropylene homopolymers or random copolymers can be produced by any known process. For example, polypropylene polymers can be prepared in the presence of Ziegler-Natta catalyst systems, based on organometallic compounds and on solids containing titanium trichloride. In some examples, the propylene polymer can be an isotactic polypropylene homopolymer. In some examples, the polymers propylene polymer can be produced using a stereospecific metallocene catalyst system.

Block copolymers can be produced similarly, except that propylene is generally initially polymerized by itself in a first stage and propylene and additional comonomers such as ethylene are then polymerized, in a second stage, in the presence of the polymer obtained during the first stage. Each of these stages can be carried out, for example, in suspension in a hydrocarbon diluent, in suspension in liquid propylene, or in gaseous phase, continuously or discontinuously, in the same reactor or in separate reactors.

In some examples, the propylene polymer can have a melt flow rate, as determined by ASTM D1238-13 at 2.16 kg, 230° C., of less than 15 g/10 min, less than 10 g/10 min, less than 5 g/10 min, less than 4 g/10 min, less than 3 g/10 min, less than 2 g/10 min, or less than 1.5 less g/10 min. The propylene polymer component can have a melt flow rate, as determined by ASTM D1238-13 at 2.16 kg, 230° C., of about 1 g/10 min to about 40 g/10 min or 1.8 g/10 min to 36 g/10 min.

In some examples, the propylene polymer can be a propylene copolymer that can include units derived from propylene and ethylene or C₄ to C₂₀ alpha-olefins. The content of the propylene units can be 80 mol % or more, 85 mol % or more, 90 mol % or more, 95 mol % or more, or 99 mol % or more. The content of the units derived from ethylene or C₄ to C₂₀ alpha-olefins can be 20 mol % or less, 15 mol % or less, 10 mol % or less, 5 mol % or less, or 1 mol % or less. In some examples, the propylene polymer can be a random copolymer comprising units derived from propylene and ethylene or C₄ to C₂₀ alpha-olefin.

In some examples, the crystallinity in the propylene polymer can be derived from isotactic or syndiotactic propylene sequences. In some examples, the isotactic propylene sequences can be obtained by use of a stereospecific metallocene catalyst and limiting the amount of comonomer. In some examples, the propylene polymer component can have an average propylene content on a molar basis of about 95% or more, about 98% or more, or 100%.

In some example, the propylene polymer can have a heat of fusion as determined by the Differential Scanning calorimetry (“DSC”) procedure described herein of about 10 J/g to about 160 J/g, about 1.9 J/g to about 151 J/g, about 28 J/g to about 142 J/g, or about 38 J/g to about 113 J/g. The crystallinity of the polypropylene copolymer arises from crystallizable stereoregular propylene sequences.

In some examples, the crystallinity of the propylene polymer can be expressed in terms of percent crystallinity. The thermal energy for the highest order of polypropylene is estimated at 207 J/g. That is, 100% crystallinity is equal to 207 J/g. Therefore, according to the aforementioned energy levels, propylene polymer component can have a crystallinity of about 5% to about 85%, about 10% to about 80%, from about 15% to about 75%, or about 20% to about 60%.

In some examples, the propylene polymer can have a g′ᵥᵢₛ branching index of at least 0.93, 0.94, 0.95, 0.96, 0.97, 0.98, 0.99, or las determined by the GPC method described herein.

In some examples, the propylene polymer at 190° C. can have a zero-shear viscosity of about 500 kPa·s, about 1,000 kPa·s, or 2,000 kPa·s. to about 3,000 kPa·s, about 4,000 kPa·s, or about 5,000 kPa·s, as defined by fitting dependence of complex viscosity on angular frequency data by Carreau-Yasuda model using TA Instruments Trios v3.3.1.4246 software.

$$\frac{η * ( ω ) - {η}_{∞}}{{η}_{0} - {η}_{∞}} = \frac{1}{{[ 1 + {( k ω )}^{a} ]}^{( 1 - n ) / a}} ,$$

with η₀ the zero-shear viscosity, η_{∞} the infinite viscosity, k the consistency and n the power law index and an a parameter describing the transition index between Newtonian plateau and power law region.

In some examples, the propylene polymer at 190° C. can have a zero-shear viscosity of about 70,000 kPa·s, about 80,000 kPa·s, or 90,000 kPa·s. to about 100,000 kPa·s, about 150,000 kPa·s, or about 200,000 kPa·s. In some examples, the propylene polymer at 190° C. can have a zero-shear viscosity of about 70,000 to about 200,000 kPa·s, or about 80,000 to about 150,000 kPa·s, or 90,000 to about 100,000 kPa·s.

In some examples, the propylene polymer at 190° C. can have a transition index of about 0.1, about 0.2, about 0.3, or about 0.4 to about 0.5, about 0.6, about 0.7, about 0.8, or about 0.9 as determined by the Carreau-Yasuda model.

In some examples, the propylene polymer at 190° C. can have a consistency (characteristic time) of about 0.05 s, about 0.1 s, about 0.2 s, or about 0.3 s to about 0.7 s, about 0.8 s, about 0.9 s, about 1.0 s, about 1.1 s, or about 1.2 s as determined by the Carreau-Yasuda model.

In some examples, the propylene polymer at 190° C. can have an infinite-rate viscosity of about −100 Pa·s, about −90 Pa·s, about −80 Pa·s, about −70 Pa·s, about −60 Pa·s to about −50 Pa·s, about −40 Pa·s, about −30 Pa·s, about −20 Pa·s, about −10 Pa·s, or about 0 Pa·s, as determined by the Carreau-Yasuda model.

In some examples, the propylene polymer at 190° C. can have a power law index of about 0.05, about 0.1, about 0.2, or about 0.3 to about 0.7, about 0.8, about 0.9, about 1.0, about 1.1, or about 1.2 as determined by the Carreau-Yasuda model.

### Propylene-Based Elastomer

The propylene-based elastomer can include units derived from propylene and about 3 wt % to about 35 wt % units derived from ethylene and/or units derived from C₄ to C₂₀ alpha-olefin(s) based on the total weight of the propylene-based elastomer. The propylene-based elastomer can have a heat of fusion, as determined by DSC, of less than 75 J/g, and a melting point, as determined by DSC, of less than 110° C., alternately less than 50J/g and less than 40° C.

The alpha-olefin comonomer can be linear or branched, and two or more comonomers can be used, if desired. In some examples, the alpha-olefin comonomers can be ethylene and/or C₄ to C₁₀ alpha-olefins. Examples of suitable alpha-olefin comonomers include butene, 1-pentene; 1-pentene with one or more methyl, ethyl, or propyl substituents; 1-hexene; 1-hexene with one or more methyl, ethyl, or propyl substituents; 1-heptene; 1-heptene with one or more methyl, ethyl, or propyl substituents; 1-octene; 1-octene with one or more methyl, ethyl, or propyl substituents; 1-nonene; 1-nonene with one or more methyl, ethyl, or propyl substituents; ethyl, methyl, or dimethyl-substituted 1-decene; 1-dodecene; and styrene.

The propylene-based elastomer can have a comonomer content (i.e., ethylene and/or C₄ to C₂₀ alpha-olefin content) of about 3 wt % to 35 wt %, based on the weight of the propylene-based elastomer. In general, the comonomer content can be adjusted so that the propylene-based elastomer can have an H_{f} of less than or equal to 75 J/g and a melt flow rate (“MFR”, ASTM D1238, 2.16 kg, 230° C.) of about 0.5 g/10 min to about 50 g/10 min. In some examples, the propylene-based elastomer can have an mm triad tacticity index of about 65% to about 99%.

The propylene-based elastomer can incorporate propylene-derived units having crystalline regions interrupted by non-crystalline regions. The non-crystalline regions can result from regions of non-crystallizable polypropylene segments and/or the inclusion of comonomer units. The crystallinity and the melting point of the propylene-based elastomer may be reduced as compared to highly isotactic polypropylene by the introduction of errors in the insertion of propylene and/or by the presence of comonomer.

In some examples, the crystallinity of the propylene-based elastomer can be reduced by the copolymerization of propylene with limited amounts of one or more comonomers selected from: ethylene, C₄ to C₂₀ alpha-olefins, and optionally dienes. Example of comonomers are ethylene, 1-butene, 1-hexene, and/or 1-octene. The propylene-based elastomer can include comonomer-derived units in an amount of 3 wt % to 35 wt %, 5 wt % to 28 wt %, 5 wt % to 25 wt %, 5 wt % to 20 wt %, 5 wt % to 16 wt %, wt % to 18 wt %, or 7 wt % to 20 wt % comonomer-derived units, based on the weight of the propylene-based elastomer. The comonomer content of the propylene-based elastomer can be determined by ¹³C NMR.

In some examples, the propylene-based elastomer can include at least 65 wt %, at least 75 wt %, at least 80 wt %, at least 82 wt %, at least 84 wt % at least 89 wt %, of propylene-derived units, based on the weight of the propylene-based elastomer. In some examples, the propylene-based elastomer can include 65 wt % to 97 wt %, 75 wt % to 95 wt %, 89 wt % to 93 wt %, or 80 wt % to 90 wt %, of propylene-derived units, based on the weight of the propylene-based elastomer.

In some examples, when more than one comonomer is present, the amount of a particular comonomer can be less than 3 wt %, but the combined comonomer content can be greater than 3 wt %. When there is more than one comonomer unit in the copolymer, the total weight percent of the ethylene and/or C₄ to C₂₀ alpha-olefin derived units can be 5 wt % to 35 wt %, 7 wt % to 32 wt %, 8 wt % to 25 wt %, 8 wt % to 20 wt %, or 8 wt % to 18 wt % based on the weight of the propylene-based elastomer. In some examples, the copolymers can have more than one comonomer, e.g., propylene-ethylene-octene, propylene-ethylene-hexene, and propylene-ethylene-butene polymers. These copolymers can further comprise a diene.

In some examples, the propylene-based elastomer can consist essentially of units derived from propylene and ethylene. The propylene-based elastomer can include 5 wt % to 35 wt % of ethylene-derived units, 5 wt % to 30 wt %, 5 wt % to 25 wt %, or 5 wt % to 20 wt % of ethylene-derived units, based on the total weight of the propylene-based elastomer. In some examples, the propylene-based elastomer can include 10 wt % to 12 wt % of ethylene-derived units, 15 wt % to 20 wt % of ethylene-derived units, or 5 wt % to 16 wt % of ethylene-derived units based on the total weight of the propylene-based elastomer.

In some examples, the propylene-based elastomer can further include one or more diene-derived units. The propylene-based elastomer can include less than or equal to 12 wt % diene-derived units (or “diene”), or less than or equal to 10 wt % diene, or less than or equal to 5 wt % diene, or less than or equal to 3 wt % diene. In some examples, the diene is present from 0.1 wt % to 9 wt %, 0.1 wt % to 6 wt %, 0.1 wt % to 5 wt %, 0.1 wt % to 4 wt %, 0.1 wt % to 2 wt %, or 0.1 wt % to 1 wt % based on the total weight of the propylene-based elastomer. In some examples, the propylene-based elastomer can include the diene in an amount of 2.0 wt % to 7.0 wt %, or 3.0 wt % to 5.0 wt %, based on the total weight of the propylene-based elastomer.

The optional diene units may be derived from any hydrocarbon structure having at least two unsaturated bonds wherein at least one of the unsaturated bonds may be incorporated into a polymer. Suitable dienes include, but are not limited to: straight chain acyclic olefins such as 1,4-hexadiene and 1,6-octadiene; branched chain acyclic olefins such as 5-methyl-1,4-hexadiene, 3,7-dimethyl-1,6-octadiene, and 3,7-dimethyl-1,7-octadiene; single ring alicyclic olefins, such as 1,4-cyclohexadiene, 1,5-cyclooctadiene, and 1,7-cyclododecadiene; multi-ring alicyclic fused and bridged ring olefins such as tetrahydroindene, methyl-tetrahydroindene, dicyclopentadiene (“DCPD”), ethylidiene norbornene (“ENB”), norbomadiene, alkenyl norbornenes, alkylidene norbomenes, cycloalkelnyl norobornenes, and cycloalkylinene norbornenes (such as 5-vinyl-2-norbornene); cycloalkenyl-substituted alkenes, such as vinyl cyclohexene, allyl cyclohexene, vinyl cyclooctene, 4-vinyl cyclohexene, alkyl cyclodecene, vinyl cyclododecene, divinyl benzene, and tetracyclo (A-11,12)-5,8-dodecene; and combinations thereof. In certain embodiments, the diene is 5-ethylidene-2-norbornene, 5-vinyl-2-norbornene, or divinyl benzene. The diene, if present, can be ENB.

The propylene-based elastomer can have a melt flow rate (“MFR”, ASTM D1238-13, 2.16 kg, 230° C.) of greater than or equal to 0.2 g/10 min, or greater than or equal to 0.5 g/10 min. In some examples, the propylene-based elastomer can have an MFR of 0.5 g/10 min to 50 g/10 min, 1 g/10 min to 40 g/10 min, 2 g/10 min to 35 g/10 min, or 2 g/10 min to 30 g/10 min. In some examples, the propylene-based elastomer can have an MFR of 0.5 to 50 g/10 min, 2 g/10 min to 10 g/10 min, 2 g/10 min to 8 g/10 min, or 3 g/10 min to 5 g/10 min. In some examples, the propylene-based elastomer's MFR can be less than 15 g/10 min, less than 10 g/10 min, less than 5 g/10 min, less than 4 g/10 min, less than 3 g/10 min, less than 2 g/10 min, or less than 1.5 less g/10 min.

In some examples, the propylene-based elastomer can have a heat of fusion (“H_{f}”), as determined by the Differential Scanning calorimetry (“DSC”) procedure described herein, of greater than or equal to 0.5 J/g, or 1 J/g, or 5 J/g, and is less than or equal to 75 J/g, or preferably less than or equal to 70 J/g, or 50 J/g, or less than or equal to 35 J/g. In some examples, the H_{f} value may be from a low value of 1.0 J/g, 1.5 J/g, 3.0 J/g, 4.0 J/g, 6.0 J/g, or 7.0 J/g to a high value of 30 J/g, 35 J/g, 40 J/g, 50 J/g, 60 J/g, 70 J/g, or 75 J/g.

The propylene-based elastomer may have a percent crystallinity of 0.5% to 40%, 1% to 30%, 5% to 35%, wherein “percent crystallinity” is determined according to the DSC procedure described herein. The thermal energy for the highest order of propylene is estimated at 207 J/g (e.g., 100% crystallinity is equal to 207 J/g). In some examples, the propylene-based elastomer can have a crystallinity less than 40% or 0.25% to 25% or 0.5% to 22%.

The procedure for DSC determinations is as follows. 0.5 grams of polymer is weighed and pressed to a thickness of 15 to 20 mils (about 381-508 microns) at 140° C.-150° C., using a “DSC mold” and MYLAR™ film as a backing sheet. The pressed polymer sample is allowed to cool to ambient temperatures by hanging in air (the MYLAR™ film backing sheet is not removed). The pressed polymer sample is then annealed at room temperature (about 23° C.-25° C.). A 15-20 mg disc is removed from the pressed polymer sample using a punch die and is placed in a 10 microliter aluminum sample pan. The disc sample is then placed in a DSC (Perkin Elmer Pyris 1 Thermal Analysis System) and is cooled to −100° C. The sample is heated at 10° C./min to attain a final temperature of 165° C. The thermal output, recorded as the area under the melting peak of the disc sample, is a measure of the heat of fusion and can be expressed in Joules per gram (J/g) of polymer and is automatically calculated by the Perkin Elmer system. Under these conditions, the melting profile shows two (2) maxims, the maxima at the highest temperature is taken as the melting point within the range of melting of the disc sample relative to a baseline measurement for the increasing heat capacity of the polymer as a function of temperature. The percent crystallinity (X %) is calculated using the formula: [area under the curve (in J/g)/H° (in J/g)]*100, where H° is the heat of fusion for the homopolymer of the major monomer component. The values for H° are to be obtained from the Polymer Handbook, Fourth Edition, published by John Wiley and Sons, New York 1999, except that a value of 290 J/g is used as the equilibrium heat of fusion (H°) for 100% crystalline polyethylene, a value of 140 J/g is used as the equilibrium heat of fusion (H°) for 100% crystalline polybutene, and a value of 207 J/g (H°) is used as the heat of fusion for a 100% crystalline polypropylene.

The propylene-based elastomer may have a single peak melting transition as determined by DSC. In some examples, the propylene-based elastomer can have a primary peak transition of less than 90° C., with a broad end-of-melt transition of greater than 110° C. The peak “melting point” (“Tm”) is defined as the temperature of the greatest heat absorption within the range of melting of the sample. However, the copolymer may show secondary melting peaks adjacent to the principal peak, and/or at the end-of-melt transition, however for the purposes herein, such secondary melting peaks are considered together as a single melting point, with the highest of these peaks being considered the Tm of the propylene-based elastomer. The propylene-based elastomer may have a Tm of less than or equal to 110° C., less than or equal to 100° C. , less than or equal to 90° C. , less than or equal to 80° C. , less than or equal to 70° C., 25° C. to 100° C., 25° C. to 85° C. , 25° C. to 75° C. , 25° C. to 65° C., 30° C. to 80° C., or 30° C. to 70° C.

The propylene-based elastomer can have a weight average molecular weight (“Mw”) of 5,000 g/mole to 5,000,000 g/mole, 10,000 g/mole to 1,000,000 g/mole, or 50,000 g/mole to 400,000 g/mole. In some examples, the propylene-based elastomer can have a Mw greater than 10,000 g/mole, greater than 15,000 g/mole, greater than 20,000 g/mole, or greater than 80,000 g/mole. In some examples, the propylene-based elastomer can have a Mw less than 5,000,000 g/mole, less than 1,000,000 g/mole, or less than 500,000 g/mole.

The propylene-based elastomer can have a number average molecular weight (“Mn”) of 2,500 g/mole to 2,500,000 g/mole, or 10,000 g/mole to 250,000 g/mole, or 50,000 g/mole to 200,000 g/mole. The propylene-based elastomer can have a Mz of 10,000 g/mole to 7,000,000 g/mole, 80,000 g/mole to 700,000 g/mole, or 100,000 g/mole to 500,000 g/mole.

The propylene-based elastomer can have a molecular weight distribution (“MWD”) (Mw/Mn) of 1.5 to 20, 1.5 to 15, 1.5 to 5, 1.8 to 5, or 1.8 to 3 or 4. In some examples, the propylene-based elastomer can have a MWD of 1.5, 1.8, or 2.0 to 4.5, 5, 10, or 20.

Techniques for determining the molecular weight (Mn, Mw, and Mz) and MWD of propylene-based elastomers are as follows, and as in Verstate et al., in 21 Macromolecules pg. 3360 (1988). Conditions described herein govern over published test conditions. Molecular weight and MWD are measured using a Waters 150 gel permeation chromatograph equipped with a Chromatix KMX-6 on-line light scattering photometer. The system is used at 135° C. with 1,2,4-trichlorobenze as the mobile phase. Showdex (Showa-Denko America, Inc.) polystyrene gel columns 802, 803, 804, and 805 are used. This technique is discussed in Liquid Chromatography of Polymers and Related Materials III, pg. 207 (J. Cazes ed., Marcel Dekker, 1981). No corrections for column spreading were employed; however, data on generally acceptable standards, e.g., National Bureau of Standards Polyethylene 1484 and anionically produced hydrogenated polyisoprenes (an alternating ethylene propylene copolymer) demonstrate that such corrections on Mw/Mn or Mz/Mw are less than 0.05 units. Mw/Mn was calculated from an elution time-molecular relationship whereas Mz/Mw was evaluated using the light scattering photometer. The numerical analysis can be performed using the commercially available computer software GPC2, MOLWT2 available from LDC/Milton Roy-Rivera Beach, Fla.

Propylene tacticity index, expressed herein as “m/r”, is determined by ¹³C nuclear magnetic resonance (“NMR”) techniques. The propylene tacticity index m/r is calculated as defined by H. N. Cheng, “¹³C NMR Analysis of Ethylene-Propylene Rubbers,” in Macromolecules, v.17, pp. 1950-1955 (1984). The designation “m” or “r” describes the stereochemistry of pairs of contiguous propylene groups, “m” referring to meso and “r” to racemic. An m/r ratio of 0 to less than 1.0 generally describes a syndiotactic polymer, and an m/r ratio of 1.0 an atactic material, and an m/r ratio of greater than 1.0 an isotactic material.

An isotactic material theoretically may have a ratio approaching infinity, and many by-product atactic polymers have sufficient isotactic content to result in ratios of greater than 50. Embodiments of the propylene-based elastomer have a propylene tacticity index m/r ranging from a lower limit of 4 or 6 to an upper limit of 8 or 10 or 12.

In a preferred embodiment, the propylene-based elastomer may have isotactic stereoregular propylene crystallinity. The term “stereoregular” as used herein means that the predominant number, i.e. greater than 80%, of the propylene residues in the polypropylene exclusive of any other monomer such as ethylene, have the same 1,2 insertion and the stereochemical orientation of the pendant methyl groups is the same, either meso or racemic.

The propylene-based elastomer can have an isotactic triad tacticity index, also referred to as mm triad tacticity index, of three propylene units, as measured by ¹³C NMR, of 75% or more, 80% or more, 82% or more, 85% or more, or 90% or more. In some examples, the mm triad tacticity index can be 50% to 99%, 60% to 99%, 75 to 99%, 80% to 99%, 70% to 98%, or 60% to 97%. The mm triad tacticity index of a polymer is the relative tacticity of a sequence of three adjacent propylene units, a chain consisting of head to tail bonds, expressed as a binary combination of m and r sequences. It is usually expressed for the copolymers of the present invention as the ratio of the number of units of the specified tacticity to all of the propylene triads in the copolymer. The mm triad tacticity index (mm fraction) of a propylene copolymer can be determined from a ¹³C NMR spectrum of the propylene copolymer and the following formula:

$$mm Fraction = \frac{PPP ( mm )}{PPP ( mm ) + PPP ( mr ) + PPP ( rr )}$$

where PPP(mm), PPP(mr) and PPP(rr) denote peak areas derived from the methyl groups of the second units in the following three propylene unit chains consisting of head-to-tail bonds:

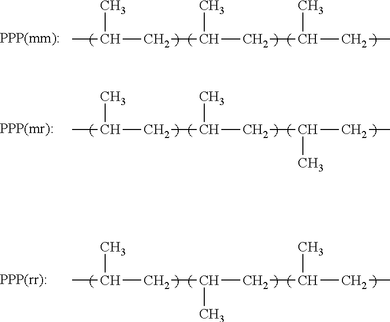

The ¹³C NMR spectrum of the propylene copolymer is measured as described in U.S. Pat. Nos. 5,504,172; and 6,642,316 (column 6, line 38 to column 9, line 18). The spectrum relating to the methyl carbon region (19-23 parts per million (ppm)) can be divided into a first region (21.2-21.9 ppm), a second region (20.3-21.0 ppm) and a third region (19.5-20.3 ppm). Each peak in the spectrum was assigned with reference to an article in the journal Polymer, v.30 (1989), page 1350 or an article in the journal Macromolecules, v.17, (1984), pg. 1950. (In the event of a conflict between the Polymer article and the Macromolecules article, the Polymer article shall control). In the first region, the methyl group of the second unit in the three propylene unit chain represented by PPP(mm) resonates. In the second region, the methyl group of the second unit in the three propylene unit chain represented by PPP(mr) resonates, and the methyl group (PPE-methyl group) of a propylene unit whose adjacent units are a propylene unit and an ethylene unit resonates (in the vicinity of 20.7 ppm). In the third region, the methyl group of the second unit in the three propylene unit chain represented by PPP(rr) resonates, and the methyl group (EPE-methyl group) of a propylene unit whose adjacent units are ethylene units resonates (in the vicinity of 19.8 ppm). The calculation of the mm triad tacticity index is outlined in the techniques shown in U.S. Pat. No. 5,504,172. Subtraction of the peak areas for the error in propylene insertions (both 2,1 and 1,3) from peak areas from the total peak areas of the second region and the third region, the peak areas based on the 3 propylene units-chains (PPP(mr) and PPP(rr)) consisting of head-to-tail bonds can be obtained. Thus, the peak areas of PPP(mm), PPP(mr) and PPP(rr) can be evaluated, and hence the mm triad tacticity index of the propylene unit chain consisting of head-to-tail bonds can be determined.

For further information on how the mm triad tacticity can be determined from a ¹³C-NMR spectrum of the polymer, as described by J. A. Ewen, “Catalytic Polymerization of Olefins”, (the Ewen method); and Eds. T. Keii, K. Soga; Kodanska Elsevier Pub.; Tokyo, 1986, P 271, and as described in detail in US Patent Application No. 2004/054086, on page 8, in numbered paragraphs [0046] to [0054].

In some examples, the propylene-based elastomer can have a density of 0.855 g/cm³ to 0.900 g/cm³, 0.860 g/cm³ to 0.895 g/cm³, or 0.860 g/cm³ to 0.890 g/cm³ at room temperature as measured per the ASTM D-1505-18 test method.

In some examples, the propylene-based elastomer can possess an Elongation at Break (ASTM D-412-16 at 23° C.) of less than 2,000%, or less than 1,000%, or less than 900%.

In some examples, the propylene-based elastomer can have a melt strength of less than 5 cN, less than 4 cN, less than 3 cN, less than 2 cN, less than 1 cN, less than 0.5 cN, or less than 0.1 cN. As used herein “melt strength” refers to the force required to draw a molten polymer extrudate at a rate of 12 mm/s2 at an extrusion temperature of 190° C. until breakage of the extrudate, whereby the force is applied by take up rollers.

In some examples, the propylene-based elastomer can have a Shore A hardness (ASTM D-2240-15e1 at 23° C.) of less than 90. In some examples, the propylene-based elastomer can have a Shore A hardness of 45 to 90 or 55 to 80.

In some examples, the propylene-based elastomer can include 80 wt % to 90 wt % propylene-derived units and 10 wt % to 20 wt % of ethylene-derived units. The propylene-based elastomer can have a density of 0.855 g/cm³ to 0.870 g/cm³ and an MFR of 2 g/10 min to 4 g/10 min. The propylene-based elastomer can have a Shore A hardness of 60 to 70. The propylene-based elastomer can have a percent crystallinity of 3% to 10%.

In some examples, the propylene-based elastomer can include 85 wt % to 95 wt % propylene-derived units and 5 wt % to 15 wt % ethylene-derived units. The propylene-based elastomer can have a density of 0.865 g/cm³ to 0.880 g/cm³ and an MFR of 2 g/10 min to 4 g/10 min. The propylene-based elastomer can have a Shore A hardness of 80 to 95. The propylene-based elastomer can have a percent crystallinity of 5% to 15%.

In some examples, the propylene-based elastomer can have a g′ᵥᵢₛ branching index of at least 0.93, 0.94, 0.95, 0.96, 0.97, 0.98, 0.99, or 1 as determined by the GPC method described herein.

In some examples, the propylene-based elastomer at 190° C. can have a zero-shear viscosity of about 500 kPa·s, about 1,000 kPa.s, or 2,000 kPa·s. to about 3,000 kPa·s, about 4,000 kPa·s, or about 5,000 kPa·s, as defined by fitting dependence of complex viscosity on angular frequency data by Carreau-Yasuda model using TA Instruments Trios v3.3.1.4246 software.

$$\frac{η * ( ω ) - {η}_{∞}}{{η}_{0} - {η}_{∞}} = \frac{1}{{[ 1 + {( k ω )}^{a} ]}^{( 1 - n ) / a}} ,$$

with η₀ the zero-shear viscosity, η_{∞} the infinite viscosity, k the consistency and n the power law index and an a parameter describing the transition index between Newtonian plateau and power law region.

In some examples, the propylene-based elastomer at 190° C. can have a transition index of about 0.1, about 0.2, about 0.3, or about 0.4 to about 0.5, about 0.6, about 0.7, about 0.8, or about 0.9 as determined by the Carreau-Yasuda model.

In some examples, the propylene-based elastomer at 190° C. can have a consistency (characteristic time) of about 0.05 s, about 0.1 s, about 0.2 s, or about 0.3 s to about 0.7 s, about 0.8 s, about 0.9 s, about 1.0 s, about 1.1 s, or about 1.2 s as determined by the Carreau-Yasuda model.

In some examples, the propylene-based elastomer at 190° C. can have an infinite-rate viscosity of about −100 Pa·s, about −90 Pa·s, about −80 Pa·s, about −70 Pa·s, about −60 Pa·s to about −50 Pa·s, about −40 Pa·s, about −30 Pa·s, about −20 Pa·s, about −10 Pa·s, or about 0 Pa·s, as determined by the Carreau-Yasuda model.

In some examples, the propylene-based elastomer at 190° C. can have a power law index of about 0.05, about 0.1, about 0.2, or about 0.3 to about 0.7, about 0.8, about 0.9, about 1.0, about 1.1, or about 1.2 as determined by the Carreau-Yasuda model.

The propylene-based elastomers described herein are not limited by any particular polymerization method for preparing the propylene-based elastomer. The propylene-based elastomers can include copolymers prepared according to the procedures disclosed in WO 2000/001745; WO 2002/036651; and U.S. Pat. Nos. 6,992,158; 6,881,800; and 7,232,871. Examples of commercially available propylene-based elastomers include resins sold under the trade names VISTAMAXX™ (ExxonMobil Chemical Company, Houston, Tex., USA) and VERSIFY™ (The Dow Chemical Company, Midland, Mich., USA).

### Ethylene-Acrylate Copolymer Blends

In some examples, the composition can include 0.5 wt % to 70 wt % or 0.5 wt % to 60 wt % of the ethylene-acrylate copolymer based on the weight of the composition. In some examples, the composition can include from a low value of 0.01 wt %, 0.1 wt %, 0.5 wt %, 1 wt %, 5 wt %, 10 wt %, 20 wt %, 30 wt %, or 40 wt %, to a high value of 70 wt %, 65 wt %, 60 wt %, 55 wt %, 50 wt %, or 45 wt % of the ethylene-acrylate copolymer, based on the weight of the composition, so long as the high value is not less than the low value.

In some examples, the composition can include 0.5 wt % to 70 wt % or 0.5 wt % to 60 wt % of the ethylene-acrylate copolymer based on a weight of the propylene polymer and the ethylene-acrylate copolymer. In some examples, the composition can include from a low value of 0.01 wt %, 0.1 wt %, 0.5 wt %, 1 wt %, 5 wt %, 10 wt %, 20 wt %, 30 wt %, or 40 wt %, to a high value of 70 wt %, 65 wt %, 60 wt %, 55 wt %, 50 wt %, or 45 wt % of the ethylene-acrylate copolymer, based on the based on a weight of the propylene polymer and the ethylene-acrylate copolymer, so long as the high value is not less than the low value.

In some examples, the composition can include 0.5 wt % to 70 wt % or 0.5 wt % to 60 wt % of the ethylene-acrylate copolymer based on a weight of the propylene-based elastomer polymer and the ethylene-acrylate copolymer. In some examples, the composition can include from a low value of 0.01 wt %, 0.1 wt %, 0.5 wt %, 1 wt %, 5 wt %, 10 wt %, 20 wt %, 30 wt %, or 40 wt %, to a high value of 70 wt %, 65 wt %, 60 wt %, 55 wt %, 50 wt %, or 45 wt % of the ethylene-acrylate copolymer, based on the based on a weight of the propylene-based elastomer and the ethylene-acrylate copolymer, so long as the high value is not less than the low value.

In some examples, the composition can include 30 wt % to 99.5 wt % of the propylene-based elastomer based on the weight of the composition. In some examples, the composition can include from a low value of 30 wt %, 35 wt %, 40 wt %, 45 wt %, 50 wt %, 60 wt %, 65 wt %, or 70 wt % to a high value of 99.5 wt %, 99 wt %, 95 wt %, 90 wt %, 85 wt %, 80 wt %, 75 wt %, or 70 wt % of the propylene-based elastomer, based on the weight of the composition so long as the high value is not less than the low value.

In some examples, the composition can include 30 wt % to 99.5 wt % of the propylene-based elastomer based on the weight of the on the weight of the propylene-based elastomer and the ethylene-acrylate copolymer. In some examples, the composition can include from a low value of 30 wt %, 35 wt %, 40 wt %, 45 wt %, 50 wt %, 60 wt %, 65 wt %, or 70 wt % to a high value of 99.5 wt %, 99 wt %, 95 wt %, 90 wt %, 85 wt %, 80 wt %, 75 wt %, or 70 wt % of the propylene-based elastomer, based on the weight of the on the weight of the propylene-based elastomer and the ethylene-acrylate copolymer so long as the high value is not less than the low value.

In some examples, the composition can include 30 wt % to 99.5 wt % of the propylene polymer based on the weight of the composition. In some examples, the composition can include from a low value of 30 wt %, 35 wt %, 40 wt %, 45 wt %, 50 wt %, 60 wt %, 65 wt %, or 70 wt % to a high value of 99.5 wt %, 99 wt %, 95 wt %, 90 wt %, 85 wt %, 80 wt %, 75 wt %, or 70 wt % of the propylene polymer, based on the weight of the composition so long as the high value is not less than the low value.

In some examples, the composition can include 30 wt % to 99.5 wt % of the propylene polymer based on the weight of the on the weight of the propylene polymer and the ethylene-acrylate copolymer. In some examples, the composition can include from a low value of 30 wt %, 35 wt %, 40 wt %, 45 wt %, 50 wt %, 60 wt %, 65 wt %, or 70 wt % to a high value of 99.5 wt %, 99 wt %, 95 wt %, 90 wt %, 85 wt %, 80 wt %, 75 wt %, or 70 wt % of the propylene polymer, based on the weight of the on the weight of the propylene polymer and the ethylene-acrylate copolymer so long as the high value is not less than the low value.

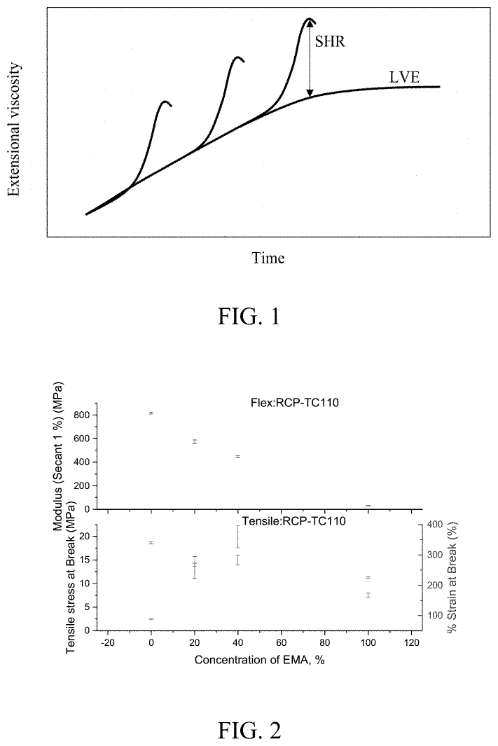

As shown in FIG. 1, strain hardening is observed as a sudden, abrupt upswing of the extensional viscosity in the transient extensional viscosity vs. time plot. This abrupt upswing, away from the linear viscoelastic behavior, was reported in the 1960s for LDPP and LDPE (reference: J. Meissner, Rheol. Acta., v.8, pg. 78, 1969) and was attributed to the presence of long branches in the polymer. The strain-hardening ratio (SHR) is defined as the ratio of the maximum transient extensional viscosity at certain strain rate over the respective value of the linear viscoelasticity envelop (LVE):

SHR(\dot{ϵ}, t)=η_{E}⁺(\dot{ϵ}, t)/3η⁺(t),

where linear viscoelasticity envelop η⁺(t) is computed as following:

η⁺(t)=Σᵢ₌₁^{N}gᵢλᵢ(1−exp(−t/λᵢ)),

with parameters gᵢ and λᵢ obtained by fitting storage and loss moduli:

$${G}^{′} ( ω ) = {\sum }_{i = 1}^{N} {g}_{i} \frac{{( ω {λ}_{i} )}^{2}}{1 + {( ω {λ}_{i} )}^{2}}$$

$${G}^{″} ( ω ) = {\sum }_{i = 1}^{N} {g}_{i} \frac{ω {λ}_{i}}{1 + {( ω {λ}_{i} )}^{2}} .$$

In some examples, the composition can have strain hardening in the material. In some examples, the strain hardening ratio can be 2 or greater, 5 or greater, 10 or greater, 15 or greater, greater than 1 to 15, or greater than 1 to 10 when extensional viscosity is measured at a Hencky strain rate of 0.01 s⁻¹ to 10 s⁻¹, e.g., 0.01 s⁻¹, 0.1 s⁻1, 1 s⁻¹, 2 s⁻¹, 3 s⁻¹, 4 s⁻¹, 5 s⁻¹, 6 s⁻¹, 7 s⁻¹, 8 s⁻¹, 9 s⁻¹, 10 s⁻¹, preferably and at a temperature of 190° C.

In some examples, the composition can contain less than 1 wt %, less than 0.5 wt %, less than 0.1 wt %, less than 0.01 wt %, or 0 wt % of a crosslinking agent based on the weight of the composition. In some examples, the composition blend can contain less than 1 wt %, less than 0.5 wt %, less than 0.1 wt %, or less than 0.01 wt % of a crosslinking agent based on the weight of the propylene polymer and the ethylene-acrylate copolymer.

In some examples, the propylene-based elastomer and the ethylene-acrylate copolymer are immiscible with one another. In some examples, the propylene polymer and the ethylene-acrylate copolymer are immiscible with one another.

In some examples, the composition can have at least two crystal melting peaks, as measured according to ASTM D3418-15. In some examples, the composition can have at least two crystallization peaks, as measured according to ASTM D3418-15. In some examples, the crystal melting peaks have a melting peak difference of at least 5° C., at least 10° C., at least 15° C., at least 20° C., at least 25° C., at least 30° C., at least 35° C., or at least 40° C. In some examples, the crystallization peaks have a crystallization peak difference of at least 5° C., at least 10° C., at least 15° C., at least 20° C., at least 25° C., at least 30° C., at least 35° C., or at least 40° C.

In some examples, the composition has at least two crystal melting peaks and at least two crystallization peaks, as measured according to ASTM D3418-15 where the crystal melting peaks have a melting peak difference of at least 5° C., at least 10° C., at least 15° C., at least 20° C., at least 25° C., at least 30° C., at least 35° C., or at least 40° C., and the crystallization peaks have a crystallization peak difference of at least 5° C., at least 10° C., at least 15° C., at least 20° C., at least 25° C., at least 30° C., at least 35° C., or at least 40° C.

In some examples, the composition has melting peaks that overlap or only show one peak, and has at least two crystallization peaks, as measured according to ASTM D3418-15, where and the crystallization peaks have a crystallization peak difference of at least 5° C., at least 10° C., at least 15° C., at least 20° C., at least 25° C., at least 30° C., at least 35° C., or at least 40° C.

The composition described herein have good shear thinning Shear thinning is determined by fitting complex viscosity versus radial frequency curve with Carreau-Yasuda model. Shear thinning can be also characterized using a shear thinning index. Shear thinning is characterized by the decrease of the complex viscosity with increasing angular frequency.

The term “shear thinning index” is determined using plots of the complex viscosity versus frequency. The slope is the ratio of complex viscosity at a frequency of 100 rad/s and at a frequency of 0.1 rad/s. These plots are exemplary output of small amplitude oscillatory shear (SAOS) experiments. For purposes of the present disclosure, the SAOS test temperature is 190° C. for propylene polymers and blends thereof. Polymer viscosity is conveniently measured in Pascal·seconds (Pa·s) as function of radial frequencies within a range of from 0.1 to 628 rad/s and at 190° C. under a nitrogen atmosphere using a dynamic mechanical spectrometer such as the TA Instruments Advanced Rheometrics Expansion System (ARES-G2). Generally a low value of shear thinning index indicates that the polymer is highly shear-thinning and that it is readily processable in high shear processes, for example by injection molding.

In some examples, the composition can have a shear thinning index of at least 0.03, 0.09, 0.10, 0.15, or 0.2. In some examples, the composition can have a shear thinning index of about 0.03, about 0.05, about 0.07, about 0.09, about 0.10 to about 0.15, about 0.18, about 0.20, about 0.25, about 0.30, about 0.35, or about 0.40.

In some examples, the composition can have a Flex modulus (Secant 1%) as determined by ASTM D790-17 of about 300 MPa, about 500 MPa, about 700 MPa, about 800 MPa, or about 900 MPa to about 1,000 MPa, about 1,500 MPa, about 2,000 MPa, about 2,500 MPa, or about 3,000 MPa.

In some examples, the composition can have a tensile stress at break as determined by ASTM D638-14 of about 5 MPa, about 8 MPa, about 10 MPa, about 12 MPa, or about 15 MPa to about 25 MPa, about 30 MPa, about 35 MPa, about 40 MPa, about 45 MPa, about 50 MPa, or about 55 MPa.

In some examples, the composition can have a tensile strain at break as determined by ASTM D638-14 of about 10%, about 15%, about 20%, about 25%, about 30%, or about 35%, to about 500%, about 600%, about 700%, about 800%, about 900%, about 1,000%, or about 1,500%.

In some examples, the composition has a Flex modulus (Secant 1%) as determined by ASTM D790 between 500 and 2,000 MPa; tensile stress at break as determined by ASTM D638 between 10 and 40 MPa; tensile strain at break as determined by ASTM D638 between 20 and 800%.

In some examples, the composition at 190° C. can have a zero-shear viscosity of about 500 kPa·s, about 1,000 kPa·s about 2,000 kPa·s, or about 3,000 kPa·s, to about 5,000 kPa·s., 6,000 kPa·s, about 7,000 kPa·s about 8,000 kPa·s, or about 10,000 kPa·s as defined by fitting dependence of complex viscosity on angular frequency data by Carreau-Yasuda model using TA Instruments Trios v3.3.1.4246 software.

$$\frac{η * ( ω ) - {η}_{∞}}{{η}_{0} - {η}_{∞}} = \frac{1}{{[ 1 + {( k ω )}^{a} ]}^{( 1 - n ) / a}} ,$$

with η₀ the zero-shear viscosity, η_{∞}the infinite viscosity, k the consistency and n the power law index and an a parameter describing the transition index between Newtonian plateau and power law region.

In some examples, the composition at 190° C. can have a zero-shear viscosity of about 100,000 kPa·s, about 110,000 kPa·s about 120,000 kPa·s, to about 200,000 kPa·s, about 220,000 kPa·s or about 250,000 kPa·s as determined by the Carreau-Yasuda model.

In some examples, the composition at 190° C. can have a transition index of about 0.1, about 0.2, about 0.3, or about 0.4 to about 0.5, about 0.6, about 0.7, about 0.8, or about 0.9 as determined by the Carreau-Yasuda model.

In some examples, the composition at 190° C. can have a consistency (characteristic time) of about 0.000001 s, about 0.00001 s, about 0.3 s, or about 0.4 s to about 0.5 s, about 0.6 s, about 0.7 s, about 0.8 s, or about 0.9 s as determined by the Carreau-Yasuda model.

In some examples, the composition at 190° C. can have a consistency (characteristic time) of less than about 1 s, less than about 0.5 s, less than about 0.1 s, less than about 0.01 s, less than about 0.001 s, or less than 0.0001 s as determined by the Carreau-Yasuda model.

In some examples, the composition at 190° C. can have an infinite-rate viscosity of about −80 Pa·s, about −70 Pa·s, about −60 Pa·s, about −50 Pa·s, about −40 Pa·s, about −30 Pa·s, about −20 Pa·s, or about −10 Pa·s, to about 0 Pa·s, about 10 Pa·s, about 20 Pa·s, about 30 Pa·s, or about 40 Pa·s, as determined by the Carreau-Yasuda model.

In some examples, the composition at 190° C. can have a power law index of about 0.05, about 0.1, about 0.2, or about 0.3 to about 0.7, about 0.8, about 0.9, about 1.0, about 1.1, or about 1.2 as determined by the Carreau-Yasuda model.

The composition described herein are useful in a wide variety of applications where a combination of light-weight, foamed aesthetics, stretchability, or elasticity are desired. The ethylene-acrylate copolymer blends can be made into films, foams, thermoformed articles, or molded articles. Examples of those applications include personal hygiene applications, such as infant diaper and training pants; apparel such as clothing, undergarments, sports apparel and gloves; film applications, such as mono-layered film or multi-layered film; roofing applications; flooring applications, such as expansion joints and flooring underlayment;

packaging applications, such as packaging for bottles, shopping bags, courier envelopes for electronics and fragile, sleeves for insulation and/or grip surface; and tape applications such as adhesive tape for irregular surfaces and mounting materials.

### Examples

The foregoing discussion can be further described with reference to the following non-limiting examples.

Unless otherwise indicated, the distribution and the moments of molecular weight (Mw, Mn, Mz, Mw/Mn, etc.), the comonomer content and the branching index (g′) are determined by using a high temperature Gel Permeation Chromatography (Polymer Char GPC-IR) equipped with a multiple-channel band-filter based Infrared detector IRS with a multiple-channel band filter based infrared detector ensemble IRS with band region covering from about 2,700 cm⁻¹ to about 3,000 cm⁻¹ (representing saturated C—H stretching vibration), an 18-angle light scattering detector and a viscometer. Three Agilent PLgel 10-μm Mixed-B LS columns are used to provide polymer separation. Reagent grade 1,2,4-trichlorobenzene (TCB) (from Sigma-Aldrich) comprising ˜300 ppm antioxidant butylated hydroxytoluene (BHT) can be used as the mobile phase at a nominal flow rate of ˜1.0 mL/min and a nominal injection volume of ˜200 μL. The whole system including transfer lines, columns, and detectors can be contained in an oven maintained at ˜145° C. A given amount of sample can be weighed and sealed in a standard vial with ˜10 μL flow marker (heptane) added thereto. After loading the vial in the auto-sampler, the oligomer or polymer may automatically be dissolved in the instrument with ˜8 mL added TCB solvent at ˜160° C. with continuous shaking. The sample solution concentration can be from ˜0.2 to ˜2.0 mg/ml, with lower concentrations used for higher molecular weight samples. The concentration, c, at each point in the chromatogram can be calculated from the baseline-subtracted IRS broadband signal, I, using the equation: c=αI, where α is the mass constant determined with polyethylene or polypropylene standards. The mass recovery can be calculated from the ratio of the integrated area of the concentration chromatography over elution volume and the injection mass which is equal to the pre-determined concentration multiplied by injection loop volume. The conventional molecular weight (IR MW) is determined by combining universal calibration relationship with the column calibration which is performed with a series of monodispersed polystyrene (PS) standards ranging from 700 to 10M gm/mole. The MW at each elution volume is calculated with following equation:

$$log M = \frac{log ( {K}_{P S} / K )}{α + 1} + \frac{{α}_{P S} + 1}{α + 1} log {M}_{P S}$$

where the variables with subscript “PS” stand for polystyrene while those without a subscript are for the test samples. In this method, α_{PS}=0.67 and K_{PS}=0.000175, α and K for other materials are as calculated and published in literature (Sun, T. et al. Macromolecules 2001, v.34, 6812), except that for purposes of this invention and claims thereto:

α=0.695+(0.01*(wt. fraction propylene)) and K=0.000579−(0.0003502*(wt. fraction propylene)) for ethylene-propylene copolymers and ethylene-propylene-diene terpolymers; α=0.695 and K=0.000579 for linear ethylene polymers, including ethylene-alkylacrylate copolymers; and

α=0.705 and K=0.0002288 for linear propylene polymers. Concentrations are expressed in g/cm³, molecular weight is expressed in g/mole, and intrinsic viscosity (hence K in the Mark-Houwink equation) is expressed in dL/g unless otherwise noted.

The comonomer composition is determined by the ratio of the IRS detector intensity corresponding to CH₂ and CH₃ channel calibrated with a series of PE and PP homo/copolymer standards whose nominal value are predetermined by NMR or FTIR. In particular, this provides the methyls per 1,000 total carbons (CH₃/1000TC) as a function of molecular weight.

The short-chain branch (SCB) content per 1000TC (SCB/1000TC) is then computed as a function of molecular weight by applying a chain-end correction to the CH₃/1000TC function, assuming each chain to be linear and terminated by a methyl group at each end. The weight % comonomer is then obtained from the following expression in which f is 0.3, 0.4, 0.6, 0.8, and so on for C3, C4, C6, C8, and so on co-monomers, respectively:

w2=f*SCB/1000TC.

The bulk composition of the polymer from the GPC-IR and GPC-4D analyses is obtained by considering the entire signals of the CH₃ and CH₂ channels between the integration limits of the concentration chromatogram. First, the following ratio is obtained:

$$Bulk IR ratio = \frac{Area of {CH}_{3} signal within integration limits}{Area of {CH}_{2} signal within integration limits} .$$

Then the same calibration of the CH₃ and CH₂ signal ratio, as mentioned previously in obtaining the CH3/1000TC as a function of molecular weight, is applied to obtain the bulk CH3/1000TC. A bulk methyl chain ends per 1000TC (bulk CH3end/1000TC) is obtained by weight-averaging the chain-end correction over the molecular-weight range. Then

w2b=f*bulk CH3/1000TC

bulk SCB/1000TC=bulk CH3/1000TC−bulk CH3end/1000TC

and bulk SCB/1000TC is converted to bulk w2 in the same manner as described above.

The LS detector is the 18-angle Wyatt Technology High Temperature DAWN HELEOSII. The LS molecular weight (M) at each point in the chromatogram is determined by analyzing the LS output using the Zimm model for static light scattering (Light Scattering from Polymer Solutions; Huglin, M. B., Ed.; Academic Press, 1972.):

$$\frac{{K}_{o} c}{Δ R ( θ )} = \frac{1}{MP ( θ )} + 2 {A}_{2} c$$

Here, ΔR(θ) is the measured excess Rayleigh scattering intensity at scattering angle θ, c is the polymer concentration determined from the IRS analysis, A₂ is the second virial coefficient, P(θ) is the form factor for a monodisperse random coil, and K_{O} is the optical constant for the system:

$${K}_{o} = \frac{4 {π}^{2} {{n}^{2} ( dn / dc )}^{2}}{{λ}^{4} {N}_{A}}$$

where N_{A} is Avogadro's number, and (dn/dc) is the refractive index increment for the system. The refractive index, n=1.500 for TCB at 145 C and λ, =665 nm. For analyzing ethylene polymers A₂=0.0015.

A high temperature Agilent (or Viscotek Corporation) viscometer, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, ηₛ, for the solution flowing through the viscometer is calculated from their outputs. The intrinsic viscosity, [η], at each point in the chromatogram is calculated from the equation [η]=η_{S}/c, where c is concentration and is determined from the IR5 broadband channel output. The viscosity MW at each point is calculated as M=K_{PS}M^{α}^{_{PS}}⁺¹/[η], where αₚₛ is 0.67 and Kₚₛ is 0.000175.

The branching index (g′ᵥᵢₛ) is calculated using the output of the GPC-IR5-LS-VIS method as follows. The average intrinsic viscosity, [η]_{avg}, of the sample is calculated by:

$${[ η ]}_{avg} = \frac{\sum {{c}_{i} [ η ]}_{i}}{\sum {c}_{i}} ,$$

where the summations are over the chromatographic slices, i, between the integration limits. The branching index g′ᵥᵢₛ is defined as

$${g}_{vis}^{′} = \frac{{[ η ]}_{avg}}{{KM}_{v}^{α}} ,$$

where M_{V} is the viscosity-average molecular weight based on molecular weights determined by LS analysis and the K and α are for the reference linear polymer, which are, for purposes of this invention and claims thereto:

α=0.695+(0.01*(wt. fraction propylene)) and K=0.000579−(0.0003502*(wt. fraction propylene) for ethylene-propylene copolymers and ethylene-propylene-diene terpolymers;

α=0.695 and K=0.000579 for linear ethylene polymers, including ethylene-alkylacrylate copolymers; and

α=0.705 and K=0.0002288 for linear propylene polymers.

Concentrations are expressed in g/cm³, molecular weight is expressed in g/mole, and intrinsic viscosity (hence K in the Mark-Houwink equation) is expressed in dL/g unless otherwise noted. Calculation of the w2b values is as discussed above.

The transient extensional viscosity was measured at 190° C. using a SER2P testing Platform available from Xpansion Instruments LLC, Tallmadge, Ohio, USA. The SER Testing Platform was used on a MCR501 rheometer available from Anton Paar. The SER Testing Platform is described in U.S. Pat. Nos. 6,578,413 and 6,691,569. A general description of transient uniaxial extensional viscosity measurements is provided, for example, in “Measuring the transient extensional rheology of polyethylene melts using the SER universal testing platform”, The Society of Rheology, Inc., J. Rheol., v.49(3), pp. 585-606 (2005). Strain hardening occurs when a polymer is subjected to elongational flow and the transient extensional viscosity increases with respect to the linear viscoelasticity envelop (LVE). Strain hardening is observed as abrupt upswing of the extensional viscosity in the transient extensional viscosity vs. time plot. A strain hardening ratio (SHR) is used to characterize the upswing in extensional viscosity and is defined as the ratio of the maximum transient extensional viscosity at certain strain rate over the respective value of the LVE. Strain hardening is present in the material when the ratio is greater than 1.

Dynamic shear melt rheological data were measured with an Advanced Rheometrics Expansion System (ARES-G2) from TA Instruments using parallel plates (diameter=25 mm) in a dynamic mode under nitrogen atmosphere. For all experiments, the rheometer was thermally stable at a temperature of about 190° C. for at least 30 minutes before inserting compression-molded sample of resin onto the parallel plates. To determine the viscoelastic behavior of the samples, frequency sweeps from 0.01 rad/s to 628 rad/s were carried out at a temperature of about 190° C. under constant strain. Depending on the molecular weight and temperature, strains in the linear deformation range verified by strain sweep test were used. A nitrogen stream was circulated through the sample oven to minimize chain extension or cross-linking during the experiments. All the samples were compression molded at about 190° C. A sinusoidal shear strain is applied to the material if the strain amplitude is sufficiently small the material behaves linearly. It can be shown that the resulting steady-state stress will also oscillate sinusoidally at the same frequency but will be shifted by a phase angle δ with respect to the strain wave. The stress leads the strain by δ. For purely elastic materials δ=0° (stress is in phase with strain) and for purely viscous materials, δ=90° (stress leads the strain by 90° although the stress is in phase with the strain rate). For viscoelastic materials, 0<δ<90.

For mechanical testing the pelletized material was used to prepare dog bones shaped samples (ISO 37 Type 3 bars) using injection molding machine BOY XS at temperatures ˜195-200° C. All the data is plotted based on mean value from 5 measurements. The Flex Test based on ASTM D790-17 has the following characteristics: specimens that are ISO 37 Type 3 bars; a span on the test fixture of 30 mm; a test speed of 1 mm/min; and a deflection of the specimens to 1.2% that captures the 1% Secant Modulus. The Tensile Test based on ASTM D638 has the following characteristics: specimens that are ISO 37 Type 3 bars; a test speed of 508 mm/min (20″/min); and a contact extensometer that attaches to specimen when elongating and detaches when the specimen breaks.

### Example 1

The samples were prepared by melt blending the materials described in Table 1 using a twin-screw extruder by Thermo Scientific Model Process 11.

The screw speed used was set to 250 rpm, the temperature in the extruder was increasing towards the die from 170° C. in the zone 2 to 205° C. at the die. The feeder speed was set to 35%. The blended material was then pelletized.

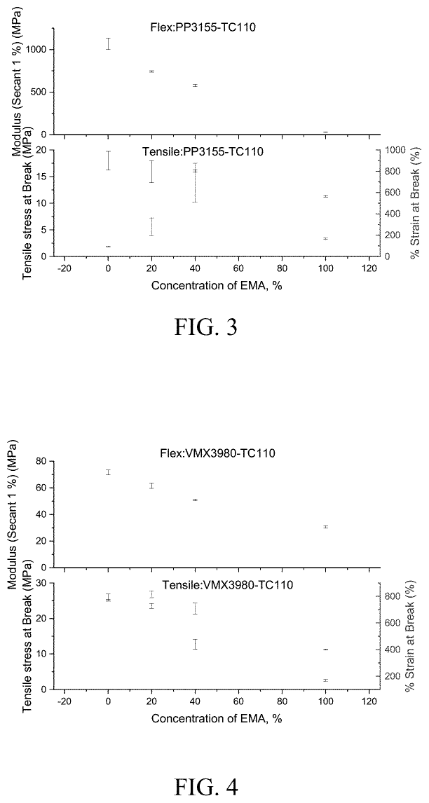

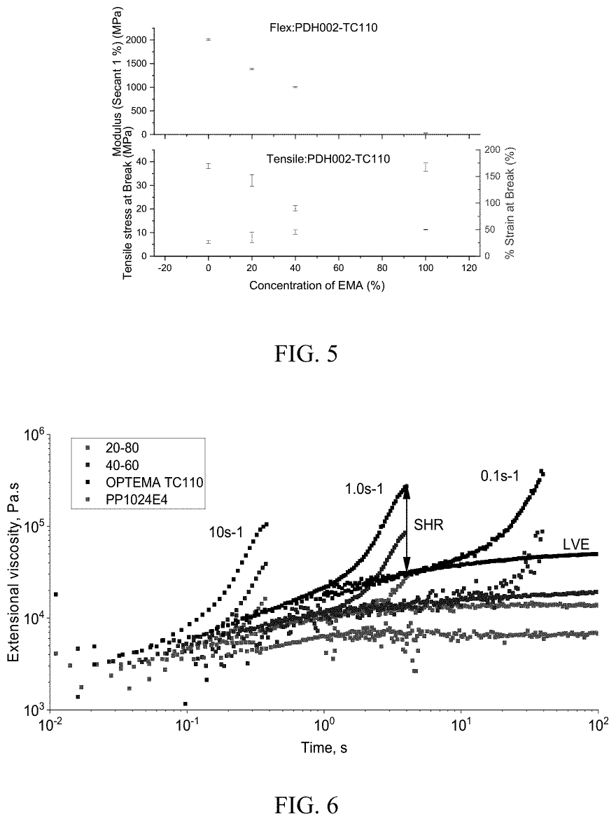

FIGS. 2-5 show the Flex modulus and stress/strain at break of the blends. The data clearly shows enhanced melt strength of the blends as compared to neat materials. Also, the ethylene methyl acrylate copolymer show well pronounced strain hardening behavior over all probed strain rates. This can be attributed to the presence of long chain branching. Due to good compatibility of ethylene methyl acrylate copolymer and propylene polymers and propylene-based elastomers this favorable rheological behavior is conveyed to the blends.

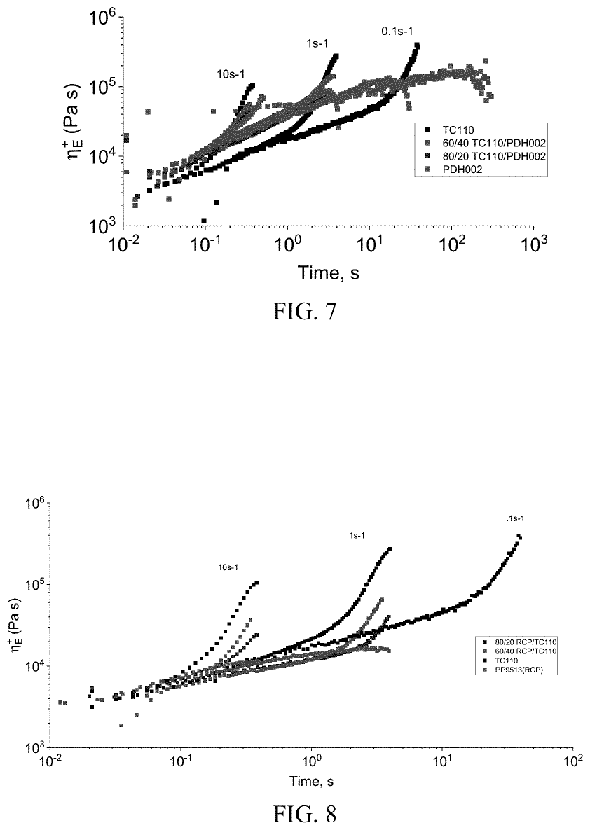

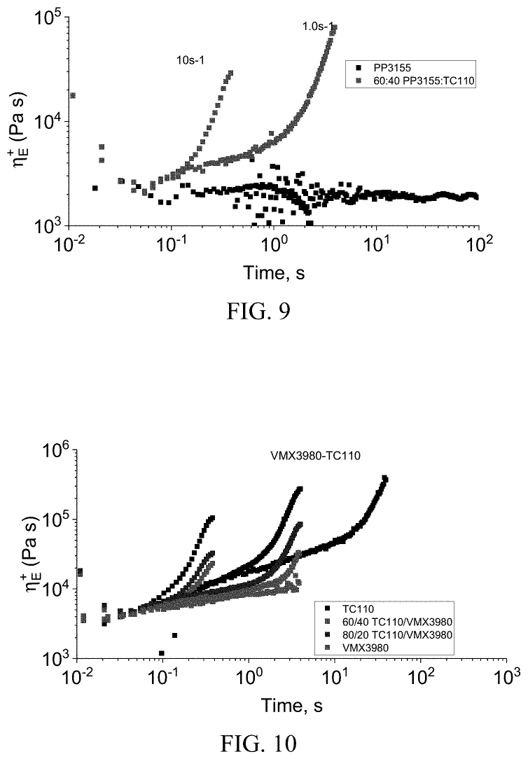

FIGS. 6-10 show graphs of the extensional viscosity data of the samples. Table 2 is a summary of the extensional rheological behavior of the samples measured at 190° C. at Hencky strain rates of 1.0 and 10.0 s⁻¹. SHRₘₐₓ that is reported in Table 2 is the larger of the two values that are measured at Hencky strain rates of 1.0 and 10.0 s⁻¹.

The data summarized in Table 3 demonstrates that ethylene methyl acrylate copolymer and the propylene polymers are characterized by well separated melting and crystallization temperatures. Upon blending their characteristic temperatures remain essentially unchanged that validates immiscibility of these components.

TABLE 3

| | T_{c, min}, | T_{c}, ₘₐₓ | T_{m, min}, | T_{m, max}, |
|---|---|---|---|---|
| Sample | ° C. | ° C. | ° C. | ° C. |
| OPTEMA ™ TC 110 | — | 61.55 | — | 81.34 |
| OPTEMA ™ TC 114 | — | 71.09 | — | 86.54 |
| OPTEMA ™ TC 220 | — | 57.05 | — | 68.91 |
| Vistamaxx ™ 3988 | | 27.74 | | 76.10 |
| (VMX3988) | | | | |
| PP9513 | — | 106.68 | — | 146.04 |
| PP1024E4 | — | 110.4 | — | 164.6 |
| 20/80 TC110/VMX3988 | 36.96 | 62.95 | 78.31 (peaks overlap) | |
| 40/60 TC110/VMX3988 | 34.99 | 63.63 | 78.11 (peaks overlap) | |
| 20/80 TC110/PP3155 | 60.96 | 119.84 | 80.34 | 163.11 |
| 40/60 TC110/PP3155 | 61.95 | 119.73 | 80.86 | 163.07 |
| 20/80 TC 110/PP1024E4 | 59.22 | 113.3 | 79.62 | 163.4 |
| 40/60 TC 110/PP1024E4 | 61.07 | 113.0 | 80.42 | 162.34 |
| 20/80 TC 114/PP1024E4 | 68.95 | 121.75 | 86.33 | 164.32 |
| 40/60 TC 114/PP1024E4 | 70.68 | 119.57 | 86.94 | 163.30 |
| 20/80 TC220/PP1024E4 | 56.50 | 120.15 | 76.93 | 164.26 |
| 40/60 TC220/PP1024E4 | 57.82 | 118.36 | 76.82 | 163.10 |
| 20/80 TC110/PP6282NE1 | 61.55 | 135.06 | 79.41 | 166.61 |
| 40/60 TC110/PP6282NE1 | 61.54 | 135.15 | 80.60 | 165.8 |
| 20/80 TC110/PP9513 | 62.48 | 112.93 | 80.50 | 148.03 |
| 40/60 TC110/PP9513 | 63.57 | 109.74 | 80.78 | 147.53 |
| 20/80 TC114/PP9513 | 69.86 | 109.71 | 86.54 | 148.18 |
| 40/60 TC114/PP9513 | 70.57 | 107.68 | 86.90 | 147.16 |

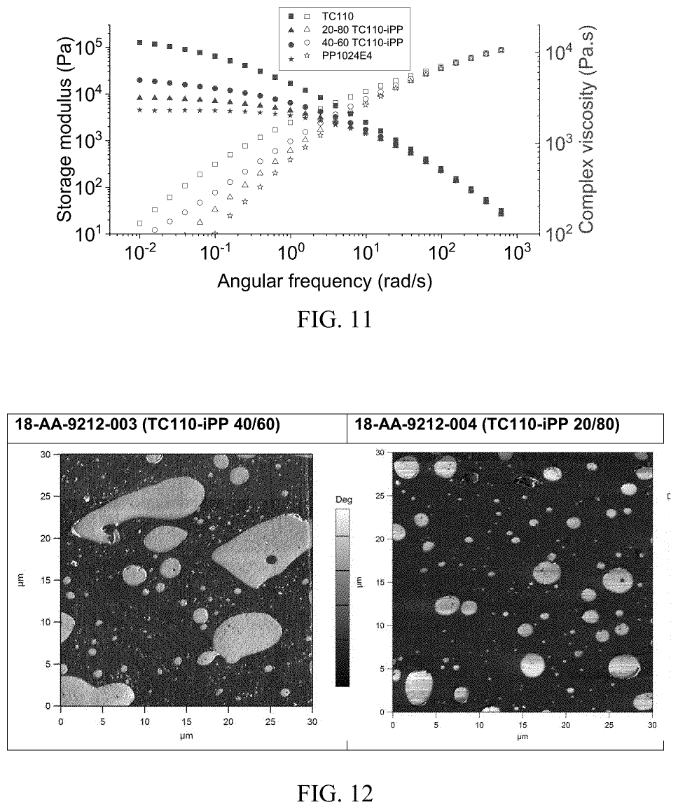

FIG. 11 and Table 4 show small angle oscillatory shear data of ethylene methyl acrylate copolymer, propylene polymers, propylene-based elastomers, and blends of the ethylene methyl acrylate copolymer with propylene polymers and propylene-based elastomers.

FIG. 12 shows the melt blends of the ethylene methyl acrylate copolymer and an isotactic polypropylene homopolymer. The mean breadth of the ethylene methyl acrylate copolymer domains in the 40/60 blend was 1,054 nm and the 20/80 blend was 1,045 nm.

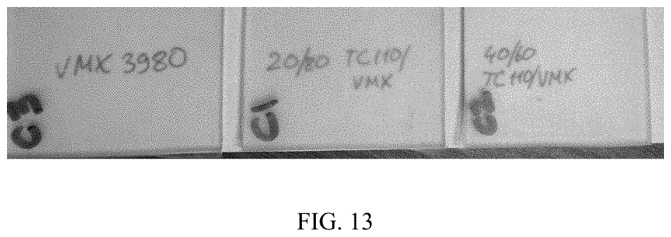

FIG. 13 demonstrates the clarity of the compression molded plaques of the propylene-based elastomer and propylene-based elastomer/ethylene methyl acrylate copolymer blends. The blends surprisingly and unexpectedly had similar optical properties to the propylene-based elastomer.

All documents described herein are incorporated by reference herein, including any priority documents and/or testing procedures to the extent they are not inconsistent with this text. Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A composition comprising: a propylene polymer and up to about 60 wt % of an ethylene-acrylate copolymer, based on a weight of the propylene polymer and the ethylene-acrylate copolymer, wherein the composition has a strain hardening ratio of greater than 1 to about 15 (alternately 10), wherein the extensional viscosity is measured at a Hencky strain rate of about 1 s⁻¹ and at a temperature of about 190° C., and wherein the ethylene-acrylate copolymer comprises units derived from ethylene and at least 5 mol % of units derived from a C₁-C₄ alkyl acrylate.

2. The composition of claim 1, wherein the propylene polymer is an isotactic polypropylene.

3. The composition of claim 1, wherein the propylene polymer is a random copolymer comprising units derived from propylene and ethylene or C₄-C₂₀ alpha-olefin.

4. The composition of claim 1, wherein the propylene polymer has a melt flow rate, as determined by ASTM D1238-13 at 2.16 kg, 230° C., of about 1 g/10 min to about 40 g/10 min.

5. The composition of claim 1, wherein the composition contains less than 0.1 wt % of a crosslinking agent based on the weight of the propylene polymer and the ethylene-acrylate copolymer.

6. The composition of claim 1, wherein the polypropylene copolymer and the ethylene acrylate copolymer are immiscible with one another.

7. The composition of claim 1, wherein the composition has at least two crystal melting and two crystallization peaks, as measured according to ASTM D3418-15.

8. The composition of claim 1, wherein the composition has at least two crystallization peaks, as measured according to ASTM D3418-15.

9. The composition of claim 1, wherein the composition has at least two crystallization peaks, as measured according to ASTM D3418-15 and the peaks have a difference of at least 15° C.

10. The composition of claim 1, wherein the alkyl acrylate comprises methyl acrylate, ethyl acrylate, propyl-acrylate, n-propyl acrylate, i-butyl acrylate, n-butyl acrylate, or mixtures thereof.

11. An article comprising the composition of claim 1.

12. The article of claim 11, wherein the article is a film, a foam, a thermoformed article, or a molded article.

13. The article of claim 11, wherein the article is a personal hygiene material, a packaging material, a roofing material, a tape material, or a flooring material.

14. A composition comprising, based on a weight of polypropylene-based elastomer and ethylene-acrylate-copolymer:
about 40 wt % to about 99.5 wt % of a propylene-based elastomer comprising units derived from propylene and about 3 wt % to about 35 wt % by weight of units derived from ethylene and/or units derived from a C₄-C₂₀ alpha-olefin, based on a weight of the propylene-based elastomer, the propylene-based elastomer having a heat of fusion, as determined by ASTM E793-06 (2018) of less than or equal to 75 J/g, and a melting point, as determined by ASTM D3418-15, of less than or equal to 110° C.; and
about 0.5 wt % to about 60 wt % of a ethylene-acrylate copolymer comprising units derived from ethylene and at least 5 mol % of units derived from a C₁-C₄ alkyl acrylate, the ethylene-acrylate copolymer having a melt index, as determined by ASTM D1238-13 at 2.16 kg, 190° C., of 5 g/10 min or less,
wherein the composition has a strain hardening ratio of greater than greater than 1 to about 15 (alternately 10), wherein the extensional viscosity is measured at a Hencky strain rate of about 1 s⁻¹ and at a temperature of 190° C.

15. The composition of claim 14, wherein the propylene-based elastomer comprises about 2.5 wt % to about 25 wt % of units derived from ethylene, based on the weight of the propylene-based elastomer.

16. The composition of claim 15, wherein the propylene-based elastomer has a melt flow rate, as determined by ASTM D1238-13 at 2.16 kg, 230° C., of about 0.2 g/10 min to about 50 g/10 min.

17. The composition of claim 15, wherein the propylene-based elastomer has a density of about 0.855 g/cm³ to about 0.900 g/cm³.

18. The composition of claim 14, wherein the propylene-based elastomer has a melt strength of less than 5 cN.

19. The composition of claim 14, wherein the propylene-based elastomer and the ethylene-acrylate copolymer are immiscible with one another.

20. The composition of claim 14, wherein the composition has at least two crystal melting and crystallization peaks, as measured according to ASTM D3418-15.

21. The composition of claim 14, wherein the composition has at least two crystallization peaks, as measured according to ASTM D3418-15.

22. The composition of claim 14, wherein the composition has at least two crystallization peaks, as measured according to ASTM D3418-15 and the crystal melting peaks have a difference of at least 15° C.

23. The composition of claim 14, wherein the alkyl acrylate comprises methyl acrylate, ethyl acrylate, propyl-acrylate, n-propyl acrylate, i-butyl acrylate, n-butyl acrylate, or mixtures thereof.

24. The composition of claim 14, wherein the propylene-based elastomer has a g′ᵥᵢₛ branching index of at least 0.95.

25. The composition of claim 14, wherein the ethylene-acrylate copolymer has a melt flow rate, as determined by ASTM D1238-13 at 2.16 kg, 190° C., of less than 3 g/10 min

26. The composition of claim 14, wherein the ethylene-acrylate copolymer has a melt index, as determined by ASTM D1238-13 at 2.16 kg, 190° C., of less than 2 g/10 min.

27. The composition of claim 1, wherein the shear thinning index of the composition is 0.03 or more, when measured at frequencies of 100 and 0.1 rad/s.

28. The composition of claim 1, wherein the shear thinning index of the composition is 0.09 or more, when measured at frequencies of 100 and 0.1 rad/s.

29. An article comprising the composition of claim 14.

30. The article of claim 29, wherein the article is a film, a foam, a thermoformed article, or a molded article.

31. The article of claim 29, wherein the article is a personal hygiene material, a packaging material, a roofing material, a tape material, or a flooring material.

32. The composition of claim 1, wherein the composition has a Flex modulus (Secant 1%) as determined by ASTM D790 between 500 and 2000 MPa; Tensile stress at break as determined by ASTM D638 between 10 and 40 MPa; Tensile strain at break as determined by ASTM D638 between 20 and 800%.

33. The composition of claim 1, wherein the composition has at least two crystal melting peaks, as measured according to ASTM D3418-15.

34. The composition of claim 1, wherein the composition has at least two crystal melting peaks, as measured according to ASTM D3418-15 and the crystal melting peaks have a difference of at least 15° C.

35. The composition of claim 14, wherein the composition has a Flex modulus (Secant 1%) as determined by ASTM D790 between 500 and 2000 MPa; Tensile stress at break as determined by ASTM D638 between 10 and 40 MPa; Tensile strain at break as determined by ASTM D638 between 20 and 800%.

36. The composition of claim 14, wherein the composition has at least two crystal melting peaks, as measured according to ASTM D3418-15.

37. The composition of claim 14, wherein the composition has at least two crystal melting peaks, as measured according to ASTM D3418-15 and the crystal melting peaks have a difference of at least 15° C.
